(19) United States
(12) Patent Application Publication
(10) Pub. No.: US 2024/0152681 A1
(43) Pub. Date: May 9, 2024

(54) GENERATING GRAPHICAL USER INTERFACES BASED ON METADATA

(71) Applicant: SAP SE, Walldorf (DE)

(72) Inventors: Snigdhaman Chatterjee, Bengaluru (IN); Sunny Yadav, Lucknow (IN); Nitin, Patna (IN); Jinata Kumari Rout, Odisha (IN); Chandresh Parmar, Rajkot (IN)

(21) Appl. No.: 18/053,261

(22) Filed: Nov. 7, 2022

(51) Int. Cl. G06F 40/103

(52) U.S. Cl. CPC G06F 40/103

(57) ABSTRACT

Some embodiments provide a non-transitory machine-readable medium that stores a program. The program may receive from a client device a request for a graphical user interface (GUI) for a form. The program may in response to the request, retrieving a set of metadata defining the GUI for the form. The program may, based on the set of metadata, generating the GUI. The program may provide the GUI to the client device.

### BACKGROUND

Graphical user interfaces (GUIs) are a type of user interface that allows users to interact with electronic devices through graphical elements displayed on a display device. For example, GUIs may include icons, buttons, menus, text boxes, etc. for interacting with electronic devices. In addition, GUIs can be used to graphically present information to users. A user can use an input device to control a cursor to interact (e.g., select, move, etc.) with the various graphical elements. Examples of input devices include a mouse, trackball, stylus, a finger on a touch screen, etc.

### SUMMARY

In some embodiments, the techniques described herein relate to a non-transitory machine-readable medium storing a program executable by at least one processing unit of a device, the program including sets of instructions for: receiving from a client device a request for a graphical user interface (GUI) for a form; in response to the request, retrieving a set of metadata defining the GUI for the form; based on the set of metadata, generating the GUI; and providing the GUI to the client device.

In some embodiments, the techniques described herein relate to a non-transitory machine-readable medium, wherein the set of metadata specifies a field and a data type for the field, wherein the program further includes a set of instructions for, based on the data type for the field, determining a user interface (UI) component to render for the field, wherein generating the GUI includes rendering the UI component for the field in the GUI.

In some embodiments, the techniques described herein relate to a non-transitory machine-readable medium, wherein the set of metadata includes a set of field definitions for a set of fields in the form, wherein a field definition in the set of field definitions includes a set of validation conditions for the field.

In some embodiments, the techniques described herein relate to a non-transitory machine-readable medium, wherein the program further includes sets of instructions for: generating a set of validation rules based on the set of validation conditions; receiving a request to submit input provided in the GUI for the form; and in response to receiving the request, applying the set of validation rules on input provided for the field.

In some embodiments, the techniques described herein relate to a non-transitory machine-readable medium, wherein the set of metadata includes a set of field definitions for a set of fields in the form, wherein a field definition in the set of field definitions includes a set of visibility conditions for the field.

In some embodiments, the techniques described herein relate to a non-transitory machine-readable medium, wherein the program further includes a set of instructions for rendering the field when the set of visibility conditions are satisfied.

In some embodiments, the techniques described herein relate to a non-transitory machine-readable medium, wherein the set of metadata includes a first field definition for a first field in the form, a second field definition for a second field in the form, and a repeatable definition specifying to replicate the second field based on a value provided in the first field, wherein the program further includes a set of instructions for rendering a set of the second field in the GUI based on the repeat definition.

In some embodiments, the techniques described herein relate to a method including: receiving from a client device a request for a graphical user interface (GUI) for a form; in response to the request, retrieving a set of metadata defining the GUI for the form; based on the set of metadata, generating the GUI; and providing the GUI to the client device.

In some embodiments, the techniques described herein relate to a method, wherein the set of metadata specifies a field and a data type for the field, the method further including, based on the data type for the field, determining a user interface (UI) component to render for the field, wherein generating the GUI includes rendering the UI component for the field in the GUI.

In some embodiments, the techniques described herein relate to a method, wherein the set of metadata includes a set of field definitions for a set of fields in the form, wherein a field definition in the set of field definitions includes a set of validation conditions for the field.

In some embodiments, the techniques described herein relate to a method further including: generating a set of validation rules based on the set of validation conditions; receiving a request to submit input provided in the GUI for the form; and in response to receiving the request, applying the set of validation rules on input provided for the field.

In some embodiments, the techniques described herein relate to a method, wherein the set of metadata includes a set of field definitions for a set of fields in the form, wherein a field definition in the set of field definitions includes a set of visibility conditions for the field.

In some embodiments, the techniques described herein relate to a method further including rendering the field when the set of visibility conditions are satisfied.

In some embodiments, the techniques described herein relate to a method, wherein the set of metadata includes a first field definition for a first field in the form, a second field definition for a second field in the form, and a repeatable definition specifying to replicate the second field based on a value provided in the first field, the method further including rendering a set of the second field in the GUI based on the repeat definition.

In some embodiments, the techniques described herein relate to a system including: a set of processing units; and a non-transitory machine-readable medium storing instructions that when executed by at least one processing unit in the set of processing units cause the at least one processing unit to: receive from a client device a request for a graphical user interface (GUI) for a form; in response to the request, retrieve a set of metadata defining the GUI for the form; based on the set of metadata, generate the GUI; and provide the GUI to the client device.

In some embodiments, the techniques described herein relate to a system, wherein the set of metadata specifies a field and a data type for the field, wherein the instructions further cause the at least one processing unit to, based on the data type for the field, determine a user interface (UI) component to render for the field, wherein generating the GUI includes rendering the UI component for the field in the GUI.

In some embodiments, the techniques described herein relate to a system, wherein the set of metadata includes a set of field definitions for a set of fields in the form, wherein a field definition in the set of field definitions includes a set of validation conditions for the field.

In some embodiments, the techniques described herein relate to a system, wherein the instructions further cause the at least one processing unit to: generate a set of validation rules based on the set of validation conditions; receive a request to submit input provided in the GUI for the form; and in response to receiving the request, apply the set of validation rules on input provided for the field.

In some embodiments, the techniques described herein relate to a system, wherein the set of metadata includes a set of field definitions for a set of fields in the form, wherein a field definition in the set of field definitions includes a set of visibility conditions for the field.

In some embodiments, the techniques described herein relate to a system, wherein the instructions further cause the at least one processing unit to render the field when the set of visibility conditions are satisfied.

The following detailed description and accompanying drawings provide a better understanding of the nature and advantages of various embodiments of the present disclosure.

### BRIEF DESCRIPTION OF THE DRAWINGS

FIG. 1 illustrates a system for generating GUIs based on metadata according to some embodiments.

FIG. 2 illustrates an example of a set of metadata for a form according to some embodiments.

FIG. 3 illustrates a GUI generated from the set of metadata illustrated in FIG. 2 according to some embodiments.

FIG. 4 illustrates an example of a set of metadata for a form according to some embodiments.

FIGS. 5A and 5B illustrate a GUI generated from the set of metadata illustrated in FIG. 3 according to some embodiments.

FIG. 6 illustrates an example of a set of metadata for a form according to some embodiments.

FIGS. 7A-7D illustrate a GUI generated from the set of metadata illustrated in FIG. 6 according to some embodiments.

FIG. 8 illustrates a process for generating GUIs based on metadata according to some embodiments.

FIG. 9 illustrates an exemplary computer system, in which various embodiments may be implemented.

FIG. 10 illustrates an exemplary computing device, in which various embodiments may be implemented.

FIG. 11 illustrates an exemplary system, in which various embodiments may be implemented.

### DETAILED DESCRIPTION

In the following description, for purposes of explanation, numerous examples and specific details are set forth in order to provide a thorough understanding of the present disclosure. It will be evident, however, to one skilled in the art that various embodiment of the present disclosure as defined by the claims may include some or all of the features in these examples alone or in combination with other features described below, and may further include modifications and equivalents of the features and concepts described herein.

Various public procurement portals (e.g., Tenders Electronic Daily (TED) in the EU) have multiple electronic notices (eNotices) to support various activities in the procurement lifecycle. These notices can be like prior information notices, contract notices, contract award notices. Each notice represents a step in the procurement lifecycle in the portal. These notices can be incredibly long and complex, with multiple pages and inter-dependent fields, with each field having its own set of validation rule. For vendors integrating with such public portals, supporting each and every notice becomes a tedious task where developers need to handcraft each notice by writing hypertext markup language (HTML) templates and then developing the associated logic to bind the user input data to their corresponding data models. ENotices can be extremely long forms, running into multiple pages. There are no scalable and high-performance metadata driven frameworks that can handle such long dynamically generated user interfaces (UIs). The UIs for the eNotices can be incredibly complex, requiring multiple group of fields or entire sections being replicated and repeated n number of times. Each of these sections in turn can have repeatable sections that needs to be processed in a recursive manner. No metadata driven UI algorithm exists to build these kinds of UIs that can dynamically place hooks into certain elements and replicate them a user defined number of times at run time. Fields or group of fields can have dependencies on other group of fields. There is no metadata driven framework to define such complex conditions and evaluate these conditions at runtime to trigger UI-specific logic like hiding/showing of fields, making fields disabled based on user inputs, etc. Similarly, entire sections and pages can also have visibility/editability conditions that need to be evaluated on the fly at runtime.

Described herein are techniques for generating GUIs based on metadata. In some embodiments, a computing system is configured to generate GUIs for forms based on metadata. For each form, a set of metadata can be used to define a GUI for the form. For example, the set of metadata associated with a form may specify the number of pages and/or sections in the form; the fields in each section; the data type, properties, validation conditions, visibility conditions, etc. of each field; etc. When the computing system receives from a client device a request for a GUI for a form, the computing system retrieves the set of metadata used to define the GUI for the form. Next, the computing system generates the GUI based on the set of metadata. Generating the GUI for the form can include generating the view of the GUI, generating the controller logic for the GUI, retrieving the data model for the GUI, and binding the data between the view and the data model. After generating the GUI for the form, the computing system provides the GUI to the client device.

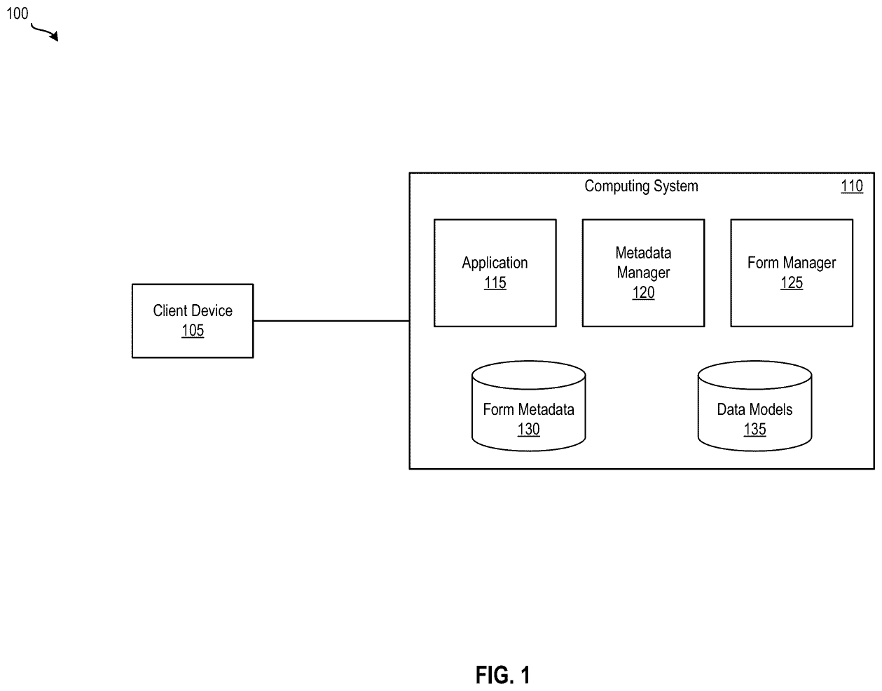

FIG. 1 illustrates a system 100 for generating GUIs based on metadata according to some embodiments. As shown, system 100 includes client device 105 and computing system 110. Client device 105 is configured to interact and communicate with computing system 110. For example, a user of client device 105 may send computing system 110 a set of metadata that defines a GUI for a form. A user of client device 105 can also send computing system 110 edits to an existing set of metadata defining a GUI for a form. As another example, a user of client device 105 can send computing system 110 a request for a GUI for a form. In response to such a request, client device 105 receives the requested GUI from computing system 110 and then displays it on a display device of client device 105. The user of client device 105 may also provide input in the GUI and submit the input to computing system 110 for processing.

Computing system 110 includes application 115, metadata manager 120, form manager 125, form metadata storage 130, and data models storage 135. Form metadata storage 130 stores sets of metadata defined for GUIs of forms. Data models storage 135 stores data models that provide the underlying data for the GUIs of forms. In some embodiments, form metadata storage 130 and data models storage 135 are implemented in a single physical storage while, in other embodiments, form metadata storage 130 and data models storage 135 may be implemented across several physical storages. While FIG. 1 shows form metadata storage 130 and data models storage 140 as part of computing system 110, one of ordinary skill in the art will appreciate that form metadata storage 130 and/or data models storage 135 may be external to computing system 110 in some embodiments.

Application 115 is a software application operating on computing system 110 configured provide GUIs of forms. In some instances, application 115 can receive from client device a request for a GUI for a form. In response to the request, application 115 forwards it to form manager 125 for processing. Application 115 can receive from form manager 125 the requested GUI for the form. Then, application 115 sends the GUI for the form to client device 105.

Metadata manager 120 is responsible for managing sets of metadata defining GUIs for forms. For instance, metadata manage 120 can receive from client device 105 a set of metadata defining a GUI for a form. In response, metadata manager 120 stores the set of metadata in form metadata storage 130. Metadata manager 120 can also handle edits to a set of metadata that defines a GUI for a form that metadata manager 120 receives from client device 105. When metadata manager 120 receives edits to a set of metadata for a GUI for a form, metadata manager 120 accesses form metadata storage 1 30 and updates the corresponding set of metadata with the edits received from client device 105.

Form manager 125 is configured to handle requests for GUIs for forms. For example, form manager 125 may receive from client device 105 a request for a GUI for a form. In response to the request, form manager 125 accesses form metadata storage 130 to retrieve a set of metadata defining the GUI for the form. Next, form manager 125 accesses data models storage 135 to retrieve the data model associated with the form. Then, form manager 125 generates the GUI for the form. In some embodiments, form manager 125 generates the GUI for the form by generating a view of the GUI, generating the controller logic for the GUI, and binding the data between the view and the data model. Finally, form manager 125 sends client device 105 the generated GUI of the form.

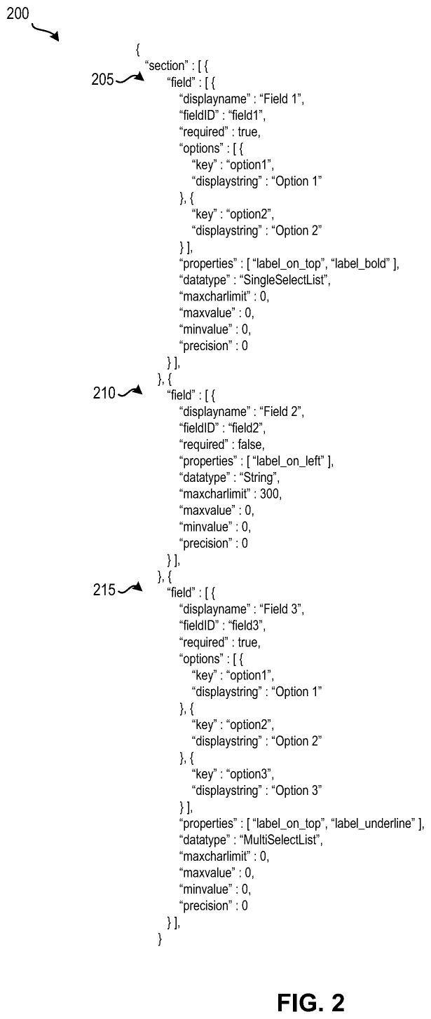

FIG. 2 illustrates an example of a set of metadata 200 for a form according to some embodiments. In some embodiments, set of metadata 200 may be formatted in a JavaScript Object Notation (JSON) format. As depicted in FIG. 2, set of metadata 200 includes a section element that includes field definitions 205-215 that each defines a field in a GUI for the form. Specifically, each of the field definitions 205-215 includes a displayname attribute specifying the name displayed for a field, a fieldID attribute specifying an identifier for identifying the field, a required attribute specifying whether the field is required for submission, a properties attribute specifying formatting for the name displayed for the field, a data type attribute specifying a data type for the field, a maxcharlimit attribute specifying a maximum character limit for the field, a maxvalue attribute specifying a maximum value for the field, a minvalue attribute specifying a minimum value for the field, and a precision attribute specifying an amount of precision of values for the field. The maxcharlimit attribute, the maxvalue attribute, the minvalue attribute, and the precision attribute may be collectively referred to as the validation conditions for a field. Field definitions 205 and 215 also each includes an options attribute specifying a set of possible values for the field.

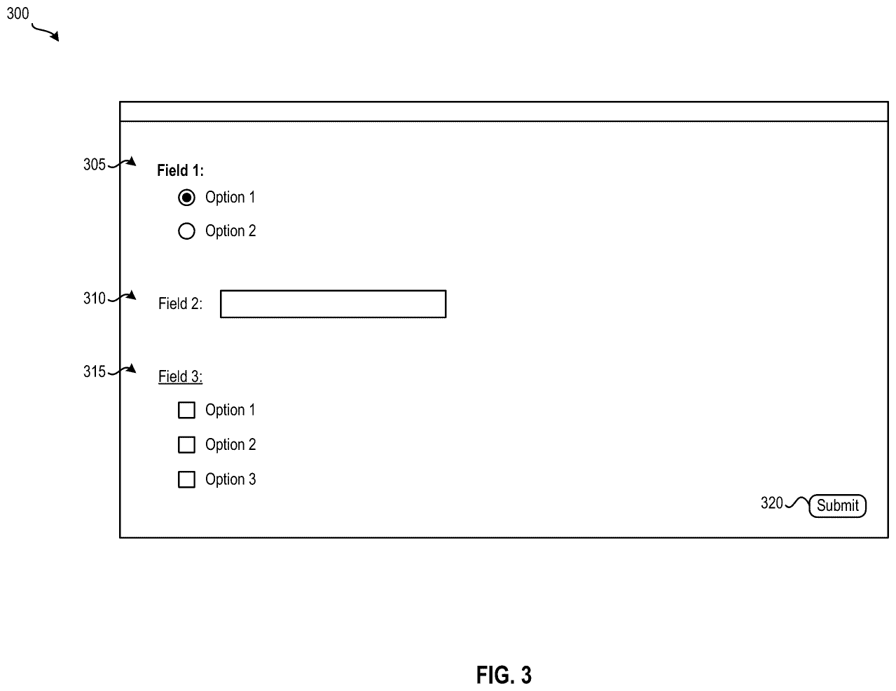

FIG. 3 illustrates a GUI 300 generated from set of metadata 200 according to some embodiments. In some embodiments, form manager 125 generates GUI 300 based on set of metadata 200 in response to receiving a request for a GUI for a form with which set of metadata 200 is associated. As illustrated, GUI 300 includes fields 305-315 and selectable user interface (UI) element 320. Selecting UI element 320 (e.g., by a user of client device 105) causes data provided in GUI 300 to be submitted to computing system 110. In this example, form manager 125 generates field 305 based on field definition 205, generates field 310 based on field definition 210, and generates field 315 based on field definition 215. In particular, form manager 125 renders the name of field 305 based on the displayname attribute and properties attribute in field definition 205. Here, form manager 125 renders “Field 1,” which is the value specified for the displayname attribute, as the name for field 305. In addition, form manager 125 renders “Field 1” in a bolded format above the UI controls (option buttons in this example) as specified in the properties attribute. Field 305 also includes two options, “Option 1” and “Option 2,” as specified by the options attribute. Form manager 125 generates different UI elements based on the data type specified for a field. For this example, form manager 125 generates a set of selectable option buttons where only one option in the set of options can be selected since the data type of a field is a singleselectlist data type. Since the values for the maxcharlimit attribute, the maxvalue attribute, the minvalue attribute, and the precision attribute are set to 0, form manager 125 ignores them.

Continuing with the example, form manager 125 renders the name of field 310 based on the displayname attribute and properties attribute in field definition 210. As shown, form manager 125 renders “Field 2,” which is the value specified for the displayname attribute, as the name for field 310. Form manager 125 also renders “Field 2” to the left of the UI controls (a textbox in this example) as specified in the properties attribute. In this example, form manager 125 generates a textbox because the data type of a field is a string data type. Field definition 210 specifies a maximum character limit of 300 characters so form manager 125 generates a validation rule for field 310 that limits the number of characters that can be entered into the textbox to 300 characters. Form manager 125 applies the validation rule to field 310 when form manager 125 receives a selection of UI element 320, for example. The values for the maxvalue attribute, the minvalue attribute, and the precision attribute are set to 0 so form manager 125 ignores them.

Finally, form manager 125 renders the name of field 315 based on the displayname attribute and properties attribute in field definition 215. In this example, form manager 125 renders “Field 3,” which is the value specified for the displayname attribute, as the name for field 315. Also, form manager 125 renders “Field 3” in an underlined format above the UI controls (checkboxes in this example) as specified in the properties attribute. Field 315 includes three options, “Option 1,” “Option 2,” and “Option 3” as specified by the options attribute. For this example, form manager 125 generates a set of selectable checkboxes where zero or more checkboxes can be selected because the data type of a field is a multiselectlist data type. As the values for the maxcharlimit attribute, the maxvalue attribute, the minvalue attribute, and the precision attribute are set to 0, form manager 125 ignores them.

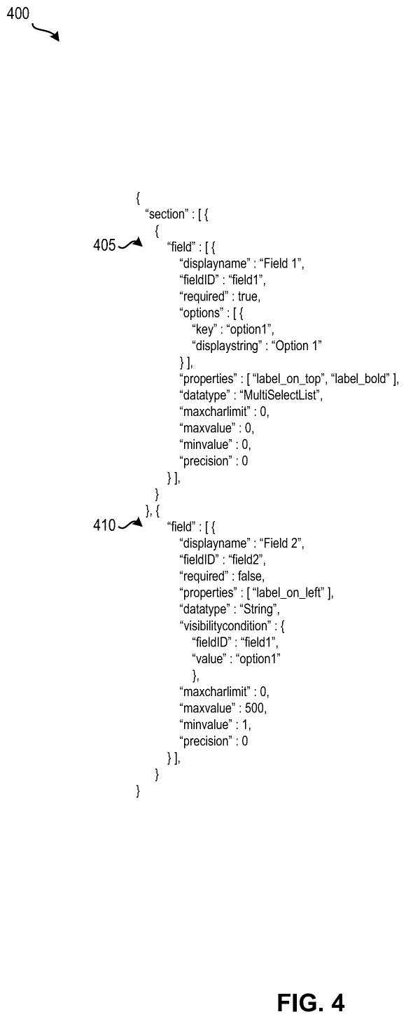

FIG. 4 illustrates an example of a set of metadata 400 for a form according to some embodiments. In some embodiments, set of metadata 400 can be formatted according to a JSON format. As illustrated in FIG. 4, set of metadata 400 includes a section element that includes field definitions 405 and 410 that each defines a field in a GUI for the form. Specifically, each of the field definitions 405 and 410 includes a displayname attribute specifying the name displayed for a field, a fieldID attribute specifying an identifier for identifying the field, a required attribute specifying whether the field is required for submission, a properties attribute specifying formatting for the name displayed for the field, a data type attribute specifying a data type for the field, a maxcharlimit attribute specifying a maximum character limit for the field, a maxvalue attribute specifying a maximum value for the field, a minvalue attribute specifying a minimum value for the field, and a precision attribute specifying an amount of precision of values for the field. The maxcharlimit attribute, the maxvalue attribute, the minvalue attribute, and the precision attribute can be collectively referred to as the validation conditions for a field. Field definition 405 further includes an options attribute specifying a set of possible values for the field. Field definition 410 also include a visibilitycondition attribute specifying a set of conditions that, when satisfied, cause the field defined by field definition to be visible.

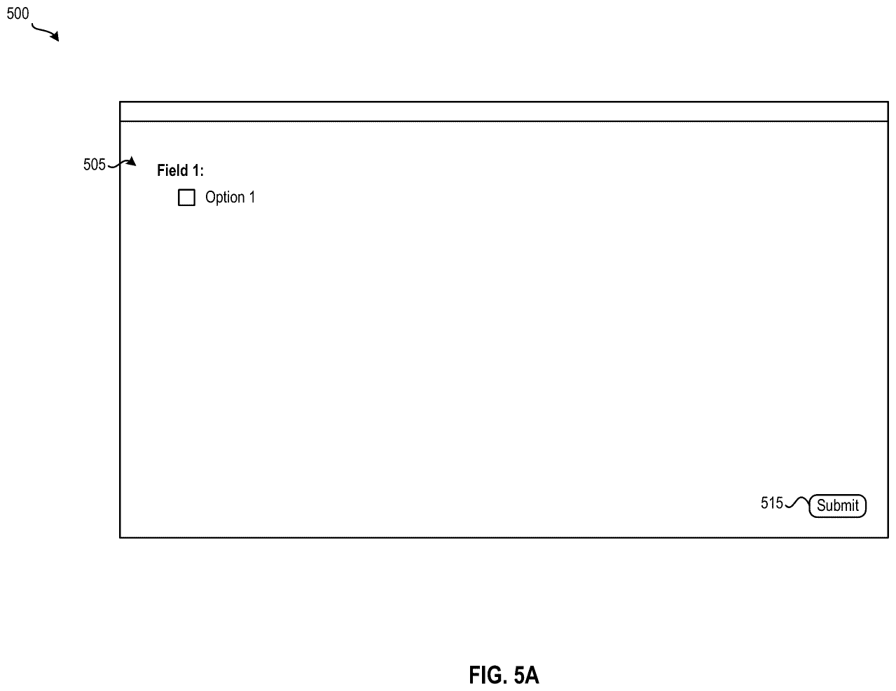

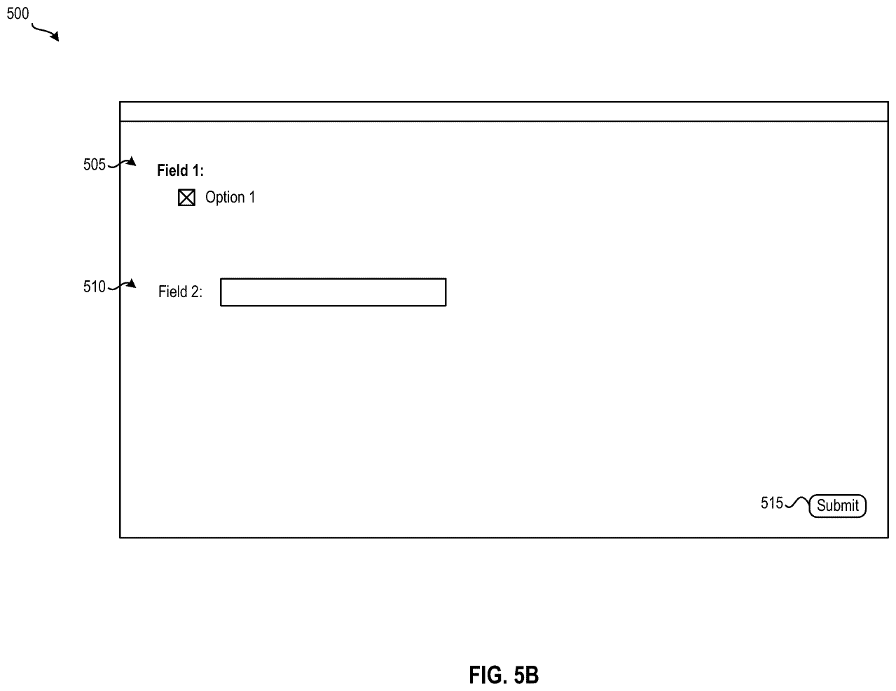

FIGS. 5A and 5B illustrate a GUI 500 generated from the set of metadata illustrated in FIG. 3 according to some embodiments. In some embodiments, form manager 125 generates GUI 500 based on set of metadata 400 in response to receiving a request for a GUI for a form with which set of metadata 400 is associated. As depicted in FIG. 5A, GUI 500 includes field 505 and selectable UI element 515. Selecting UI element 515 (e.g., by a user of client device 105) causes data provided in GUI 500 to be submitted to computing system 110. Here, form manager 125 generates field 505 based on field definition 405 and generates field 510 based on field definition 410. In particular, form manager 125 renders the name of field 505 based on the displayname attribute and properties attribute in field definition 405. In this example, form manager 125 renders “Field 1,” which is the value specified for the displayname attribute, as the name for field 505. Form manager 125 also renders “Field 1” in a bolded format above the UI controls (a checkbox in this example) as specified in the properties attribute. Field 505 also includes an option, “Option 1,” as specified by the options attribute. As mentioned above, form manager 125 generates different UI elements based on the data type specified for a field. For this example, form manager 125 generates a set of selectable checkboxes where zero or more checkboxes can be selected as the data type of a field is a multiselectlist data type. Because the values for the maxcharlimit attribute, the maxvalue attribute, the minvalue attribute, and the precision attribute are set to 0, form manager 125 ignores them.

Continuing with this example, form manager 125 does not render the field defined by field definition 410 since the visibility conditions specified in field definition 410 are not satisfied. The set of visibility conditions in field definition 410 specifies that Option 1 in field 505 needs to be selected in order to satisfy them. As such, when Option 1 is selected (e.g., by a user of client device 105), form manager renders the field defined by field definition 410 in response to the selection. FIG. 5B illustrates GUI 500 after Option 1 of field 505 is selection. As shown, field 510 is displayed in GUI 500. Form manager 125 renders the name of field 510 based on the displayname attribute and properties attribute in field definition 410. As depicted in FIG. 5B, form manager 125 renders “Field 2,” which is the value specified for the displayname attribute, as the name for field 510. In addition, form manager 125 renders “Field 2” to the left of the UI controls (a textbox in this example) as specified in the properties attribute. For this example, form manager 125 generates a textbox since the data type of a field is a string data type. Field definition 410 specifies a minimum value of 1 and a maximum value of 500 so form manager 125 generates a validation rule for field 510 that limits the number that can be entered into the textbox to a number between 1 and 500. Form manager 125 applies the validation rule to field 510 when form manager 125 receives a selection of UI element 515, for example. The values for the maxcharlimit attribute and the precision attribute are set to 0. Therefore, form manager 125 ignores them.

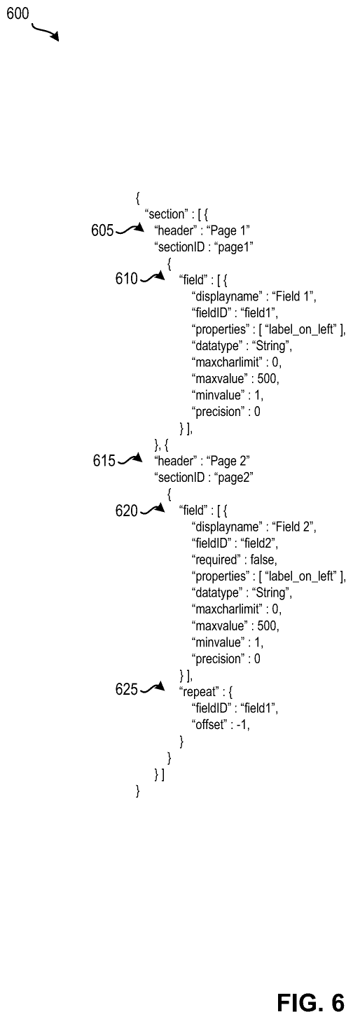

FIG. 6 illustrates an example of a set of metadata 600 for a form according to some embodiments. In some embodiments, set of metadata 600 may be formatted according to a JSON format. As shown in FIG. 6, set of metadata 600 includes a section element that includes two child subsections 605 and 615. In this example, each child subsection element represents a different page in the GUI for the form. Subsection 605 includes field definition 610 while subsection 615 includes field definition 620. Each of the field definitions 610 and 620 includes a displayname attribute specifying the name displayed for a field, a fieldID attribute specifying an identifier for identifying the field, a required attribute specifying whether the field is required for submission, a properties attribute specifying formatting for the name displayed for the field, a data type attribute specifying a data type for the field, a maxcharlimit attribute specifying a maximum character limit for the field, a maxvalue attribute specifying a maximum value for the field, a minvalue attribute specifying a minimum value for the field, and a precision attribute specifying an amount of precision of values for the field. The maxcharlimit attribute, the maxvalue attribute, the minvalue attribute, and the precision attribute may be collectively referred to as the validation conditions for a field. Additionally, subsection 615 includes repeat definition 625. Here, repeat definition 625 specifies to replicate fields defined by field definition 620. The number of fields to replicate is based on a set of conditions specified in repeat definition 625.

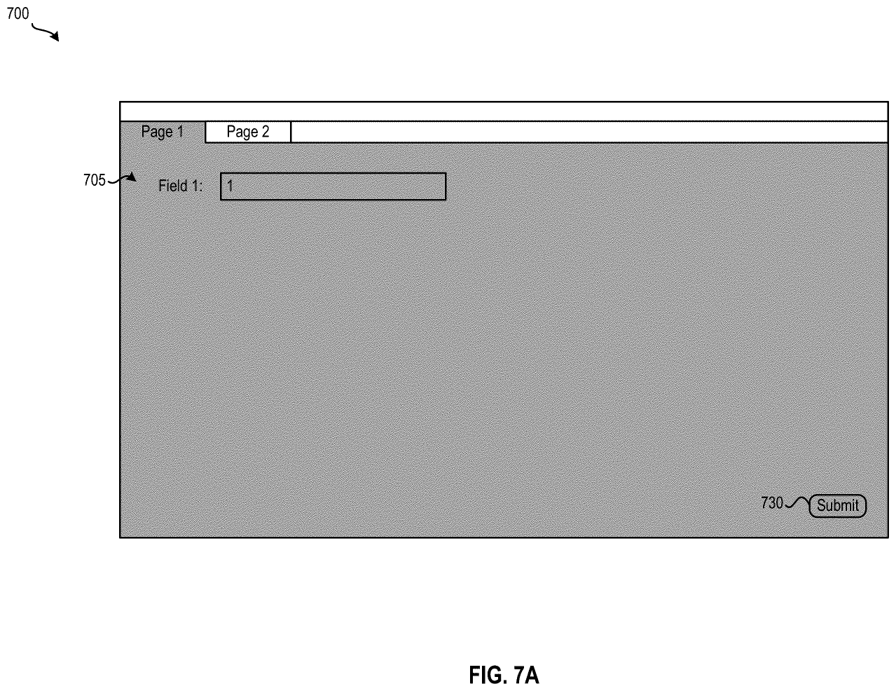

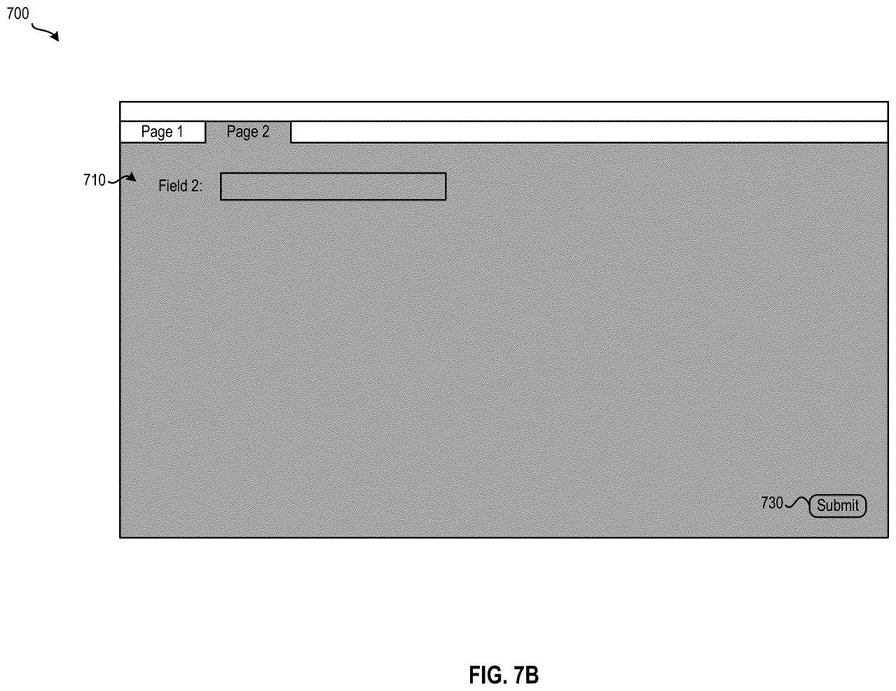

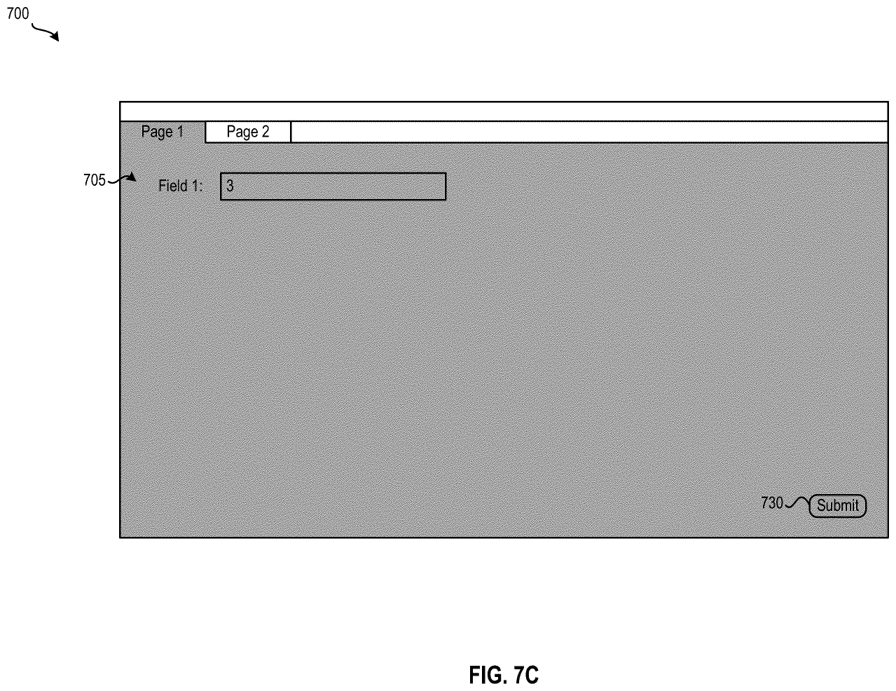

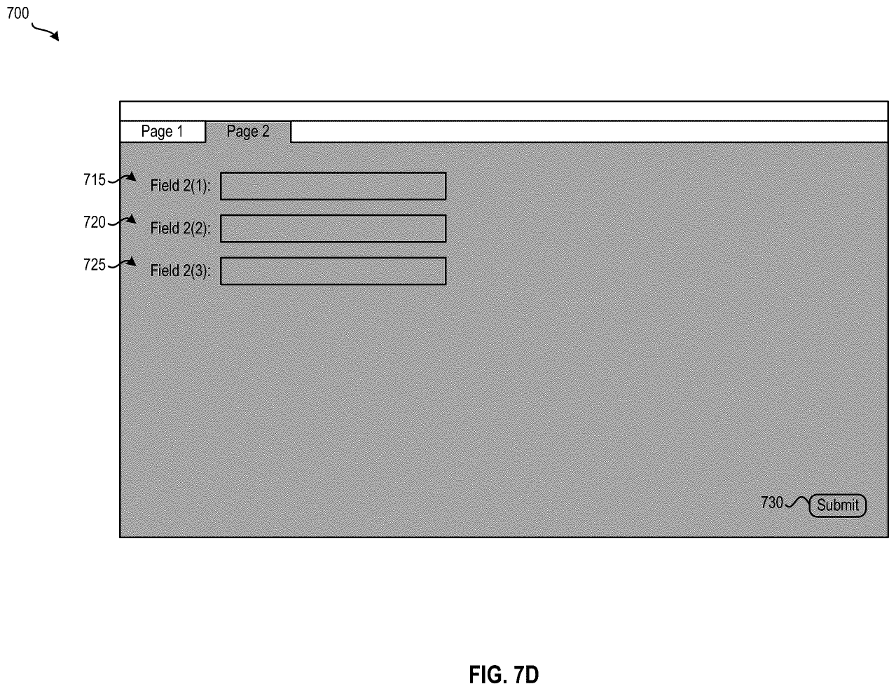

FIGS. 7A-7D illustrate a GUI 700 generated from set of metadata 600 according to some embodiments. In some embodiments, form manager 125 generates GUI 700 based on set of metadata 600 in response to receiving a request for a GUI for a form with which set of metadata 600 is associated. As illustrated in FIG. 7A, GUI 700 includes field 705 and selectable UI element 730. Selecting UI element 730 (e.g., by a user of client device 105) causes data provided in GUI 700 to be submitted to computing system 110. Here, form manager 125 generates field 705 based on field definition 610. Specifically, form manager 125 renders the name of field 705 based on the displayname attribute and properties attribute in field definition 610. In this example, form manager 125 renders “Field 1,” which is the value specified for the displayname attribute, as the name for field 705. Additionally, form manager 125 renders “Field 1” to the left of the UI controls (a textbox in this example) as specified in the properties attribute. In this example, form manager 125 generates a textbox as the data type of a field is a string data type. Field definition 610 specifies a minimum value of 1 and a maximum value of 500 so form manager 125 generates a validation rule for field 705 that limits the number that can be entered into the textbox to a number between 1 and 500. Form manager 125 applies the validation rule to field 705 when form manager 125 receives a selection of UI element 730, for example. The values for the maxcharlimit attribute and the precision attribute are set to 0. Thus, form manager 125 ignores them.

As described above, each child subsection element represents a different page in the GUI for the form. Hence, form manager 125 renders field 705 on a first of two pages of GUI 700. Different pages of GUI 700 may be navigated to by selecting the corresponding tab element (a selectable “Page 1” tab and a selectable “Page 2” tab in this example). Here, input has been provided (e.g., by a user of client device 105) in field 705 with a value of 1. In response to receiving this input, form manager 125 renders a field defined by field definition 620 on the second page of GUI 700. FIG. 7B illustrates the second page of GUI 700 after form manager 125 renders the field. As shown, the second page of GUI 700 includes field 710 and selectable UI element 730. For this example, form manager 125 generates field 710 based on field definition 620. Form manager 125 renders the name of field 710 based on the displayname attribute and properties attribute in field definition 620. In this example, form manager 125 renders “Field 2,” which is the value specified for the displayname attribute, as the name for field 710. Form manager 125 also renders “Field 2” to the left of the UI controls (a textbox in this example) as specified in the properties attribute. For this example, form manager 125 generates a textbox because the data type of a field is a string data type. Field definition 620 specifies a minimum value of 1 and a maximum value of 500 so form manager 125 generates a validation rule for field 710 that limits the number that can be entered into the textbox to a number between 1 and 500. Form manager 125 applies the validation rule to field 710 when form manager 125 receives a selection of UI element 730, for example. The values for the maxcharlimit attribute and the precision attribute are set to 0 so form manager 125 ignores them.

As mentioned above, subsection 615 includes repeat definition 625, which specifies to replicate fields defined by field definition 620 where the number of fields to replicate is based on a set of conditions specified in repeat definition 625. In this example, the number of fields to replicate is one less than the value provided in field 705. FIG. 7C illustrates the first page of GUI 700 with a different value provided in field 705. As illustrated, a value of 3 has been provided in field 705 (e.g., by a user of client device 105). Upon receiving this value, form manager 125 renders a field defined by field definition 620 on the second page of GUI 700. Form manager 125 also renders two additional fields defined by field definition 620. FIG. 7D illustrates the second page of GUI 700 after form manager 125 renders these three fields. As depicted, the second page of GUI 700 includes fields 715-725. Form manager 125 renders each of the fields 715-725 in the similar manner as that used to render field 710 in FIG. 7B except form manager 125 renders the names of fields 715-725 differently. Since fields 715-725 are rendered based on the same field definition 620, form manager 125 renders the name of fields 715-725 as “Field 2(1),” Field 2(2),” and “Field 2(3), respectively, to indicate that fields 715-725 are duplicates of the same field.

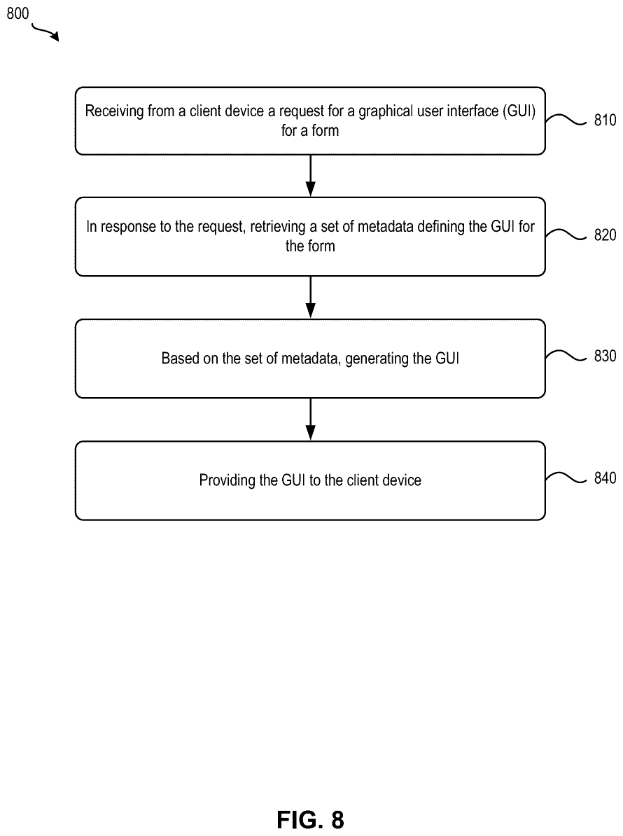

FIG. 8 illustrates a process 800 for generating GUIs based on metadata according to some embodiments. In some embodiments, form manager 125 performs process 800. Process 800 begins by receiving, at 810, from a client device a request for a graphical user interface (GUI) for a form. Referring to FIGS. 1 and 2 as an example, form manager 125 can receive a request for a GUI for a form with which set of metadata 200 is associated.

In response to the request, process 800 retrieves, at 820, a set of metadata defining the GUI for the form. Referring to FIGS. 1 and 2 as an example, form manager 125 may access form metadata storage 130 to retrieve set of metadata 200. Based on the set of metadata, process 800 generates, at 830, the GUI. Referring to FIGS. 1 and 3 as an example, form manager 125 can generate GUI 300 for the form by generating a view of GUI 300, generating the controller logic for the GUI, and binding the data between the view and the data model associated with GUI 300.

Finally, process 800 provides, at 840, the GUI to the client device. Referring to FIG. 1 as an example, form manager 125 may provide GUI 300 for the form to client device 105.

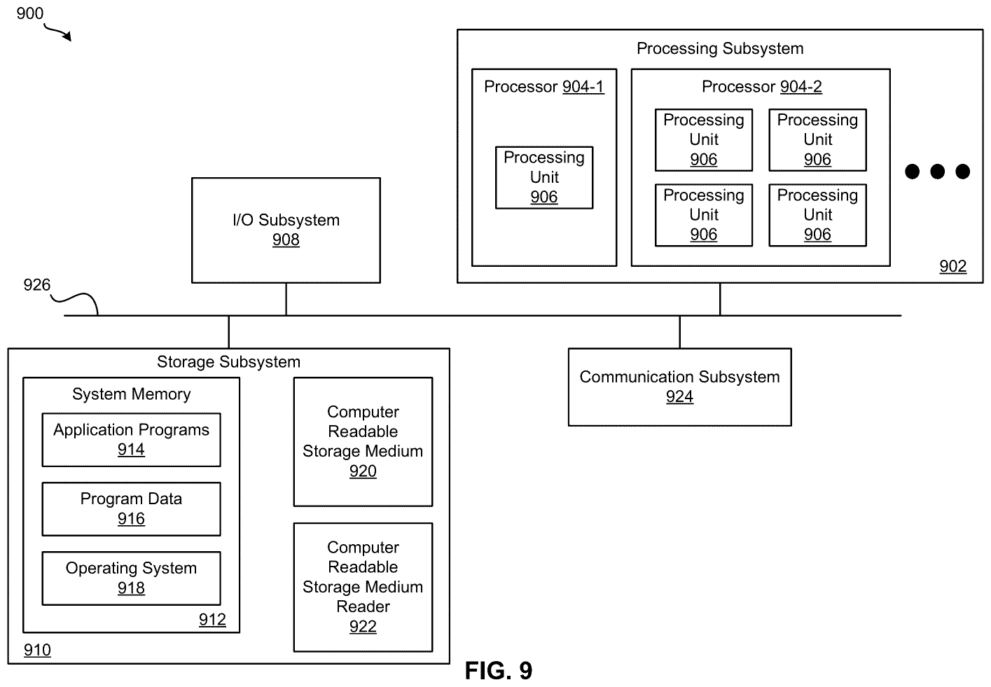

FIG. 9 illustrates an exemplary computer system 900 for implementing various embodiments described above. For example, computer system 900 may be used to implement client device 105 and computing system 110. Computer system 900 may be a desktop computer, a laptop, a server computer, or any other type of computer system or combination thereof. Some or all elements of application 115, metadata manager 120, form manager 125, or combinations thereof can be included or implemented in computer system 900. In addition, computer system 900 can implement many of the operations, methods, and/or processes described above (e.g., process 800). As shown in FIG. 9, computer system 900 includes processing subsystem 902, which communicates, via bus subsystem 926, with input/output (I/O) subsystem 908, storage subsystem 910 and communication subsystem 924.

Bus subsystem 926 is configured to facilitate communication among the various components and subsystems of computer system 900. While bus subsystem 926 is illustrated in FIG. 9 as a single bus, one of ordinary skill in the art will understand that bus subsystem 926 may be implemented as multiple buses. Bus subsystem 926 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Extended ISA (EISA) bus, a Video Electronics Standards Association (VESA) local bus, a Peripheral Component Interconnect (PCI) bus, a Universal Serial Bus (USB), etc.

Processing subsystem 902, which can be implemented as one or more integrated circuits (e.g., a conventional microprocessor or microcontroller), controls the operation of computer system 900. Processing subsystem 902 may include one or more processors 904. Each processor 904 may include one processing unit 906 (e.g., a single core processor such as processor 904-1) or several processing units 906 (e.g., a multicore processor such as processor 904-2). In some embodiments, processors 904 of processing subsystem 902 may be implemented as independent processors while, in other embodiments, processors 904 of processing subsystem 902 may be implemented as multiple processors integrate into a single chip or multiple chips. Still, in some embodiments, processors 904 of processing subsystem 902 may be implemented as a combination of independent processors and multiple processors integrated into a single chip or multiple chips.

In some embodiments, processing subsystem 902 can execute a variety of programs or processes in response to program code and can maintain multiple concurrently executing programs or processes. At any given time, some or all of the program code to be executed can reside in processing subsystem 902 and/or in storage subsystem 910. Through suitable programming, processing subsystem 902 can provide various functionalities, such as the functionalities described above by reference to process 800, etc.

I/O subsystem 908 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 900 to a user or another device (e.g., a printer).

As illustrated in FIG. 9, storage subsystem 910 includes system memory 912, computer-readable storage medium 920, and computer-readable storage medium reader 922. System memory 912 may be configured to store software in the form of program instructions that are loadable and executable by processing subsystem 902 as well as data generated during the execution of program instructions. In some embodiments, system memory 912 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 912 may include different types of memory, such as static random access memory (SRAM) and/or dynamic random access memory (DRAM). System memory 912 may include a basic input/output system (BIOS), in some embodiments, that is configured to store basic routines to facilitate transferring information between elements within computer system 900 (e.g., during start-up). Such a BIOS may be stored in ROM (e.g., a ROM chip), flash memory, or any other type of memory that may be configured to store the BIOS.

As shown in FIG. 9, system memory 912 includes application programs 914 (e.g., application 115), program data 916, and operating system (OS) 918. OS 918 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 920 may be a non-transitory computer-readable medium configured to store software (e.g., programs, code modules, data constructs, instructions, etc.). Many of the components (e.g., application 115, metadata manager 120, and form manager 125) and/or processes (e.g., process 800) described above may be implemented as software that when executed by a processor or processing unit (e.g., a processor or processing unit of processing subsystem 902) performs the operations of such components and/or processes. Storage subsystem 910 may also store data used for, or generated during, the execution of the software.

Storage subsystem 910 may also include computer-readable storage medium reader 922 that is configured to communicate with computer-readable storage medium 920. Together and, optionally, in combination with system memory 912, computer-readable storage medium 920 may comprehensively represent remote, local, fixed, and/or removable storage devices plus storage media for temporarily and/or more permanently containing, storing, transmitting, and retrieving computer-readable information.

Computer-readable storage medium 920 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSDs), flash memory card (e.g., secure digital (SD) cards, CompactFlash cards, etc.), USB flash drives, or any other type of computer-readable storage media or device.

Communication subsystem 924 serves as an interface for receiving data from, and transmitting data to, other devices, computer systems, and networks. For example, communication subsystem 924 may allow computer system 900 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 924 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 924 may provide components configured for wired communication (e.g., Ethernet) in addition to or instead of components configured for wireless communication.

One of ordinary skill in the art will realize that the architecture shown in FIG. 9 is only an example architecture of computer system 900, and that computer system 900 may have additional or fewer components than shown, or a different configuration of components. The various components shown in FIG. 9 may be implemented in hardware, software, firmware or any combination thereof, including one or more signal processing and/or application specific integrated circuits.

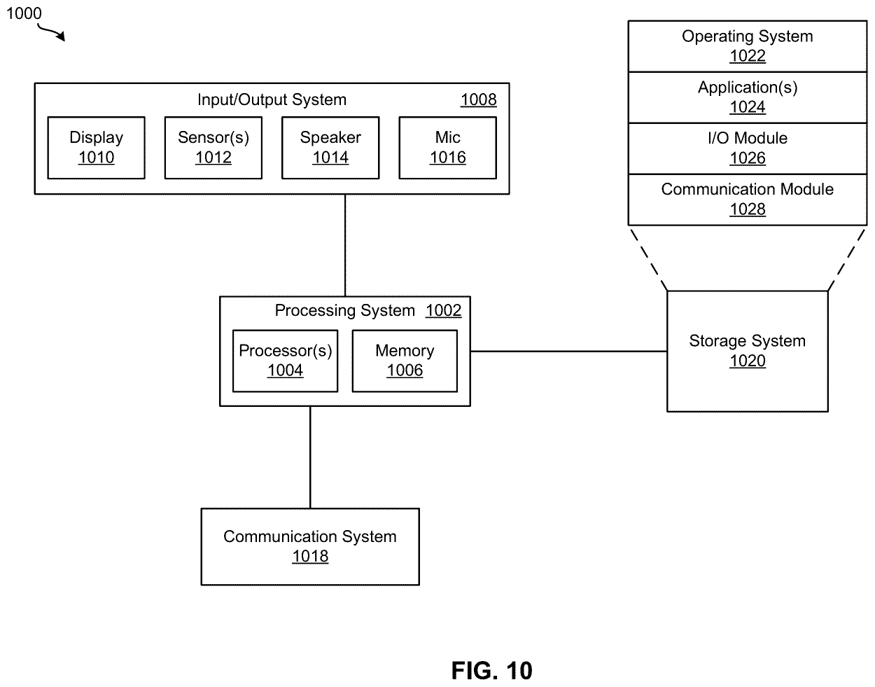

FIG. 10 illustrates an exemplary computing device 1000 for implementing various embodiments described above. For example, computing device 1000 may be used to implement client device 105. Computing device 1000 may be a cellphone, a smartphone, a wearable device, an activity tracker or manager, a tablet, a personal digital assistant (PDA), a media player, or any other type of mobile computing device or combination thereof. As shown in FIG. 10, computing device 1000 includes processing system 1002, input/output (I/O) system 1008, communication system 1018, and storage system 1020. These components may be coupled by one or more communication buses or signal lines.

Processing system 1002, which can be implemented as one or more integrated circuits (e.g., a conventional microprocessor or microcontroller), controls the operation of computing device 1000. As shown, processing system 1002 includes one or more processors 1004 and memory 1006. Processors 1004 are configured to run or execute various software and/or sets of instructions stored in memory 1006 to perform various functions for computing device 1000 and to process data.

Each processor of processors 1004 may include one processing unit (e.g., a single core processor) or several processing units (e.g., a multicore processor). In some embodiments, processors 1004 of processing system 1002 may be implemented as independent processors while, in other embodiments, processors 1004 of processing system 1002 may be implemented as multiple processors integrated into a single chip. Still, in some embodiments, processors 1004 of processing system 1002 may be implemented as a combination of independent processors and multiple processors integrated into a single chip.

Memory 1006 may be configured to receive and store software (e.g., operating system 1022, applications 1024, I/O module 1026, communication module 1028, etc. from storage system 1020) in the form of program instructions that are loadable and executable by processors 1004 as well as data generated during the execution of program instructions. In some embodiments, memory 1006 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 1008 is responsible for receiving input through various components and providing output through various components. As shown for this example, I/O system 1008 includes display 1010, one or more sensors 1012, speaker 1014, and microphone 1016. Display 1010 is configured to output visual information (e.g., a graphical user interface (GUI) generated and/or rendered by processors 1004). In some embodiments, display 1010 is a touch screen that is configured to also receive touch-based input. Display 1010 may be implemented using liquid crystal display (LCD) technology, light-emitting diode (LED) technology, organic LED (OLED) technology, organic electro luminescence (OEL) technology, or any other type of display technologies. Sensors 1012 may include any number of different types of sensors for measuring a physical quantity (e.g., temperature, force, pressure, acceleration, orientation, light, radiation, etc.). Speaker 1014 is configured to output audio information and microphone 1016 is configured to receive audio input. One of ordinary skill in the art will appreciate that I/O system 1008 may include any number of additional, fewer, and/or different components. For instance, I/O system 1008 may include a keypad or keyboard for receiving input, a port for transmitting data, receiving data and/or power, and/or communicating with another device or component, an image capture component for capturing photos and/or videos, etc.

Communication system 1018 serves as an interface for receiving data from, and transmitting data to, other devices, computer systems, and networks. For example, communication system 1018 may allow computing device 1000 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 1018 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 1018 may provide components configured for wired communication (e.g., Ethernet) in addition to or instead of components configured for wireless communication.

Storage system 1020 handles the storage and management of data for computing device 1000. Storage system 1020 may be implemented by one or more non-transitory machine-readable mediums that are configured to store software (e.g., programs, code modules, data constructs, instructions, etc.) and store data used for, or generated during, the execution of the software.

In this example, storage system 1020 includes operating system 1022, one or more applications 1024, I/O module 1026, and communication module 1028. Operating system 1022 includes various procedures, sets of instructions, software components and/or drivers for controlling and managing general system tasks (e.g., memory management, storage device control, power management, etc.) and facilitates communication between various hardware and software components. Operating system 1022 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 1024 can include any number of different applications installed on computing device 1000. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 1026 manages information received via input components (e.g., display 1010, sensors 1012, and microphone 1016) and information to be outputted via output components (e.g., display 1010 and speaker 1014). Communication module 1028 facilitates communication with other devices via communication system 1018 and includes various software components for handling data received from communication system 1018.

One of ordinary skill in the art will realize that the architecture shown in FIG. 10 is only an example architecture of computing device 1000, and that computing device 1000 may have additional or fewer components than shown, or a different configuration of components. The various components shown in FIG. 10 may be implemented in hardware, software, firmware or any combination thereof, including one or more signal processing and/or application specific integrated circuits.

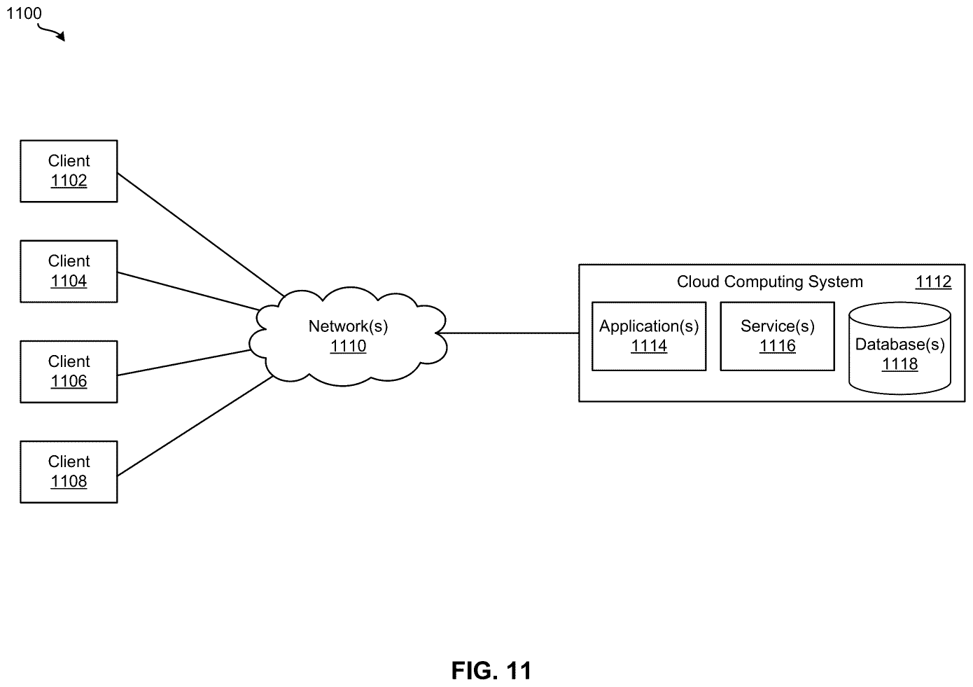

FIG. 11 illustrates an exemplary system 1100 for implementing various embodiments described above. For example, one of the client devices 1102-1108 may be used to implement client device 105 and cloud computing system 1112 may be used to implement computing system 110. As shown, system 1100 includes client devices 1102-1108, one or more networks 1110, and cloud computing system 1112. Cloud computing system 1112 is configured to provide resources and data to client devices 1102-1108 via networks 1110. In some embodiments, cloud computing system 1112 provides resources to any number of different users (e.g., customers, tenants, organizations, etc.). Cloud computing system 1112 may be implemented by one or more computer systems (e.g., servers), virtual machines operating on a computer system, or a combination thereof.

As shown, cloud computing system 1112 includes one or more applications 1114, one or more services 1116, and one or more databases 1118. Cloud computing system 1112 may provide applications 1114, services 1116, and databases 1118 to any number of different customers in a self-service, subscription-based, elastically scalable, reliable, highly available, and secure manner.

In some embodiments, cloud computing system 1112 may be adapted to automatically provision, manage, and track a customer's subscriptions to services offered by cloud computing system 1112. Cloud computing system 1112 may provide cloud services via different deployment models. For example, cloud services may be provided under a public cloud model in which cloud computing system 1112 is owned by an organization selling cloud services and the cloud services are made available to the general public or different industry enterprises. As another example, cloud services may be provided under a private cloud model in which cloud computing system 1112 is operated solely for a single organization and may provide cloud services for one or more entities within the organization. The cloud services may also be provided under a community cloud model in which cloud computing system 1112 and the cloud services provided by cloud computing system 1112 are shared by several organizations in a related community. The cloud services may also be provided under a hybrid cloud model, which is a combination of two or more of the aforementioned different models.

In some instances, any one of applications 1114, services 1116, and databases 1118 made available to client devices 1102-1108 via networks 1110 from cloud computing system 1112 is referred to as a “cloud service.” Typically, servers and systems that make up cloud computing system 1112 are different from the on-premises servers and systems of a customer. For example, cloud computing system 1112 may host an application and a user of one of client devices 1102-1108 may order and use the application via networks 1110.

Applications 1114 may include software applications that are configured to execute on cloud computing system 1112 (e.g., a computer system or a virtual machine operating on a computer system) and be accessed, controlled, managed, etc. via client devices 1102-1108. In some embodiments, applications 1114 may include server applications and/or mid-tier applications (e.g., HTTP (hypertext transfer protocol) server applications, FTP (file transfer protocol) server applications, CGI (common gateway interface) server applications, JAVA server applications, etc.). Services 1116 are software components, modules, application, etc. that are configured to execute on cloud computing system 1112 and provide functionalities to client devices 1102-1108 via networks 1110. Services 1116 may be web-based services or on-demand cloud services.

Databases 1118 are configured to store and/or manage data that is accessed by applications 1114, services 1116, and/or client devices 1102-1108. For instance, storages 130 and 135 may be stored in databases 1118. Databases 1118 may reside on a non-transitory storage medium local to (and/or resident in) cloud computing system 1112, in a storage-area network (SAN), on a non-transitory storage medium local located remotely from cloud computing system 1112. In some embodiments, databases 1118 may include relational databases that are managed by a relational database management system (RDBMS). Databases 1118 may be a column-oriented databases, row-oriented databases, or a combination thereof. In some embodiments, some or all of databases 1118 are in-memory databases. That is, in some such embodiments, data for databases 1118 are stored and managed in memory (e.g., random access memory (RAM)).

Client devices 1102-1108 are configured to execute and operate a client application (e.g., a web browser, a proprietary client application, etc.) that communicates with applications 1114, services 1116, and/or databases 1118 via networks 1110. This way, client devices 1102-1108 may access the various functionalities provided by applications 1114, services 1116, and databases 1118 while applications 1114, services 1116, and databases 1118 are operating (e.g., hosted) on cloud computing system 1112. Client devices 1102-1108 may be computer system 900 or computing device 1000, as described above by reference to FIGS. 9 and 10, respectively. Although system 1100 is shown with four client devices, any number of client devices may be supported.

Networks 1110 may be any type of network configured to facilitate data communications among client devices 1102-1108 and cloud computing system 1112 using any of a variety of network protocols. Networks 1110 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

1. A non-transitory machine-readable medium storing a program executable by at least one processing unit of a device, the program comprising sets of instructions for:
receiving from a client device a request for a graphical user interface (GUI) of a form;
in response to the request, retrieving a set of metadata defining the GUI of the form, wherein the set of metadata comprises a set of field definitions for a set of fields in the form, wherein each field definition in the set of field definitions comprises a data type for a field in the set of fields and a set of validation conditions for the field in the set of fields;
for each field in the set of fields, determining a user interface (UI) component to render for the field based on the data type for the field specified in the field definition in the set of field definitions for the field;
based on the set of metadata, generating the GUI, wherein generating the GUI comprises rendering, in the GUI, the UI component for each field in the set of fields; and
providing the GUI to the client device.

2. (canceled)

3. (canceled)

4. The non-transitory machine-readable medium of claim 1, wherein the program further comprises sets of instructions for:
generating a set of validation rules based on the set of validation conditions;
receiving a request to submit input provided in the GUI for the form; and
in response to receiving the request, applying the set of validation rules on input provided for the field.

5. The non-transitory machine-readable medium of claim 1, wherein the set of metadata comprises a set of field definitions for a set of fields in the form, wherein a field definition in the set of field definitions comprises a set of visibility conditions for the field.

6. The non-transitory machine-readable medium of claim 5, wherein the program further comprises a set of instructions for rendering the field when the set of visibility conditions are satisfied.

7. The non-transitory machine-readable medium of claim 1, wherein the set of metadata comprises a first field definition for a first field in the form, a second field definition for a second field in the form, and a repeatable definition specifying to replicate the second field based on a value provided in the first field, wherein the program further comprises a set of instructions for rendering a set of the second field in the GUI based on the repeatable definition.

8. A method comprising:
receiving from a client device a request for a graphical user interface (GUI) of a form;
in response to the request, retrieving a set of metadata defining the GUI of the form, wherein the set of metadata comprises a set of field definitions for a set of fields in the form, wherein each field definition in the set of field definitions comprises a data type for a field in the set of fields and a set of validation conditions for the field in the set of fields;
for each field in the set of fields, determining a user interface (UI) component to render for the field based on the data type for the field specified in the field definition in the set of field definitions for the field;
based on the set of metadata, generating the GUI, wherein generating the GUI comprises rendering, in the GUI, the UI component for each field in the set of fields; and
providing the GUI to the client device.

9. (canceled)

10. (canceled)

11. The method of claim 8 further comprising:
generating a set of validation rules based on the set of validation conditions;
receiving a request to submit input provided in the GUI for the form; and
in response to receiving the request, applying the set of validation rules on input provided for the field.

12. The method of claim 8, wherein the set of metadata comprises a set of field definitions for a set of fields in the form, wherein a field definition in the set of field definitions comprises a set of visibility conditions for the field.

13. The method of claim 12 further comprising rendering the field when the set of visibility conditions are satisfied.

14. The method of claim 8, wherein the set of metadata comprises a first field definition for a first field in the form, a second field definition for a second field in the form, and a repeatable definition specifying to replicate the second field based on a value provided in the first field, the method further comprising rendering a set of the second field in the GUI based on the repeatable definition.

15. A system comprising:
a set of processing units; and
a non-transitory machine-readable medium storing instructions that when executed by at least one processing unit in the set of processing units cause the at least one processing unit to:
receive from a client device a request for a graphical user interface (GUI) of a form;
in response to the request, retrieve a set of metadata defining the GUI of the form, wherein the set of metadata comprises a set of field definitions for a set of fields in the form, wherein each field definition in the set of field definitions comprises a data type for a field in the set of fields and a set of validation conditions for the field in the set of fields;
for each field in the set of fields, determine a user interface (UI) component to render for the field based on the data type for the field specified in the field definition in the set of field definitions for the field;
based on the set of metadata, generate the GUI, wherein generating the GUI comprises rendering, in the GUI, the UI component for each field in the set of fields; and
provide the GUI to the client device.

16. (canceled)

17. (canceled)

18. The system of claim 15, wherein the instructions further cause the at least one processing unit to:
generate a set of validation rules based on the set of validation conditions;
receive a request to submit input provided in the GUI for the form; and
in response to receiving the request, apply the set of validation rules on input provided for the field.

19. The system of claim 15, wherein the set of metadata comprises a set of field definitions for a set of fields in the form, wherein a field definition in the set of field definitions comprises a set of visibility conditions for the field.

20. The system of claim 19, wherein the instructions further cause the at least one processing unit to render the field when the set of visibility conditions are satisfied.

21. The non-transitory machine-readable medium of claim 1, wherein the request includes edits to the set of metadata defining the graphical user interface of the form, wherein the request further comprises input data corresponding to one or more data models associated with the form, wherein generating the GUI further comprises:
retrieving a data model of the one or more data models associated with the form;
generating a view of the GUI of the form;
generating controller logic for the GUI;
binding, according to the generated controller logic for the GUI, the input data between the view of the GUI of the form and the data model of the one or more data models associated with the form;
rendering, for each field in the set of metadata, a UI component in the view of the GUI as specified in the set of metadata; and
wherein providing the GUI further comprises providing the view of the GUI comprising the rendered UI components to the client device.

22. The method of claim 8, wherein the request includes edits to the set of metadata defining the graphical user interface of the form, wherein the request further comprises input data corresponding to one or more data models associated with the form, wherein generating the GUI further comprises:
retrieving a data model of the one or more data models associated with the form;
generating a view of the GUI of the form;
generating controller logic for the GUI;
binding, according to the generated controller logic for the GUI, the input data between the view of the GUI of the form and the data model of the one or more data models associated with the form;
rendering, for each field in the set of metadata, a UI component in the view of the GUI as specified in the set of metadata; and
wherein providing the GUI further comprises providing the view of the GUI comprising the rendered UI components to the client device.

23. The system of claim 15, wherein the request includes edits to the set of metadata defining the graphical user interface of the form, wherein the request further comprises input data corresponding to one or more data models associated with the form, wherein generating the GUI further comprises:
retrieving a data model of the one or more data models associated with the form;
generating a view of the GUI of the form;
generating controller logic for the GUI;
binding, according to the generated controller logic for the GUI, the input data between the view of the GUI of the form and the data model of the one or more data models associated with the form;
rendering, for each field in the set of metadata, a UI component in the view of the GUI as specified in the set of metadata; and
wherein providing the GUI further comprises providing the view of the GUI comprising the rendered UI components to the client device.

24. The non-transitory machine-readable medium of claim 1, wherein the set of validation conditions for each field in the set of fields comprises a same set of attributes and wherein values for each attribute of the same set of attributes are based on the data type for the field.

25. The method of claim 8, wherein the set of validation conditions for each field in the set of fields comprises a same set of attributes and wherein values for each attribute of the same set of attributes are based on the data type for the field.

26. The system of claim 15, wherein the set of validation conditions for each field in the set of fields comprises a same set of attributes and wherein values for each attribute of the same set of attributes are based on the data type for the field.
